(19) United States
(12) Patent Application Publication
(10) Pub. No.: US 2015/0100343 A1
(43) Pub. Date: Apr. 9, 2015

(54) MEDICATION ADHERENCE SYSTEM AND METHOD

(71) Applicant: GLOBAL HEALTH TRANSFORMATIONS, INC., FRANKLIN, TN (US)

(72) Inventors: JOHN A. SIEDLECKI, FRANKLIN, TN (US); ALEXANDER POSTION, FRANKLIN, TN (US)

(21) Appl. No.: 14/509,847

(22) Filed: Oct. 8, 2014

Related U.S. Application Data
(60) Provisional application No. 61/888,378, filed on Oct. 8, 2013.

(51) Int. Cl. G06F 19/00

(52) U.S. Cl. CPC G06F 19/3456; G06F 19/3418
USPC 705/2

(57) ABSTRACT

A computer-based system and related methods for improving and sustaining patient adherence, compliance and persistence with a medication plan, regimen or regime. The system works with a particular prescription medication or medications, or for a daily or periodic regimen of multiple prescription medications. It provides real-time reminders and alerts to patients for quality-assured patient self-administration of medication at the correct point in time for each scheduled medication dose, and determines adherence scores and ratings for a variety of medication adherence factors. It can be accessed on mobile computing devices, or through a web-based browser.

This application claims benefit of and priority to U.S. Provisional Application No. 61/888,378, filed Oct. 8, 2013, by John Siedlecki, et al., and is entitled to that filing date for priority. The specification, figures and complete disclosure of U.S. Provisional Application No. 61/888,378 are incorporated herein by specific reference for all purposes.

### FIELD OF INVENTION

This invention relates to a system and method for improving and sustaining patient adherence, compliance and persistence with a medication plan, regimen or regime.

### BACKGROUND OF THE INVENTION

Lack of medication adherence by patients is a significant and costly problem. Medication adherence (i.e., taking the right medicine in the right doses on the right schedule) averages only approximately 50% among patients with chronic conditions in the developed countries, including the United States. Patients not taking medications as prescribed puts them at risk for serious adverse health conditions, including death. The leading cause of non-compliance is behavioral; that is, the patient is forgetful or procrastinates, thus missing a dose or being late in obtaining a renewal or refill of a prescription.

Further, non-compliance accounts for approximately 12% of total health care expenditures in the United States. Non-adherence results in frequent re-admissions and additional hospitalizations, emergency department visits, diagnostic tests, physician office visits, and surgeries and other procedures. It is estimated that medication non-adherence results is an annualized cost of from $290 billion to $319 billion to the U.S. healthcare system.

A variety of ways to encourage compliance are known in the prior art, but with limited success. Accordingly, what is needed is a system and method that addresses the root causes of non-compliance, and encourages medication adherence by patients.

### SUMMARY OF INVENTION

In various exemplary embodiments, the present invention comprises a system and related methods for improving and sustaining patient adherence, compliance and persistence with a medication plan, regimen or regime (any reference to the terms adherence, compliance and persistence herein, individually or in combination, should be construed to encompass all three terms). The system may work with a particular prescription medication or medications, or for a daily or periodic regimen of multiple prescription medications.

The system promotes adherence behavior by patients, and increases medication adherence performance and rates. It continuously initiates, stimulates, motivates, educates, instructs, guides, reinforces and rewards compliant behavior by patients through a variety of means described herein. It thus provides quality-assured patient self-administration of medication at the correct point in time for each scheduled medication dose. Further, the system provides real-time dosing alerts and adherence results, provides real-time problem solving for non-compliant behavior, coordinates with physicians and other healthcare providers, and overcomes behavioral, clinical and cost barriers to medication compliance.

In one embodiment, the system comprises a centralized or “cloud-based” network accessible through the Internet, or a public or private network. Users may access the system through a Web browser, an application program on a smart phone, tablet computer, or other mobile computer device, or a dedicated computing device or service.

In one exemplary embodiment, the system supports instantaneous exchange and storage of adherence related data and information among and between various users of the system, including, but not limited to, consumers, patients, providers, health-care professionals (e.g., physicians, nurse practitioners, physician assistants, case managers, discharge planners, care coordinators, health coaches, and pharmacists) insurers, and system administrators. Access is limited to those authorized to receive information from the system by the corresponding patient or consumer user, pursuant to HIPAA and other applicable regulatory guidelines or rules.

In several embodiments, adherence-related data and information comprises outbound and inbound messages. Outbound messages are sent by the system to a patient, consumer, or other user. Inbound messages are sent to the system by patient, consumer, or other source. In one embodiment, the messages are in digital electronic form, serially identifiable, discrete, and may be medication-specific and dose-specific. In one form, the messages are time-stamped and date-stamped patient engagement messages, with the primary purpose and function to stimulate or help initiate a certain sequence of patient adherence behavior activities or events, or a combination thereof, by the patient or consumer user. Inbound messages from the patient or consumer user provide data and information that validates whether some or all of that sequence of patient adherence behavior activities or events have been carried out by the patient. Compliance can be indicated as “in-part”, “in-full”, or “not-at-all.”

In one particular embodiment, the system assigns and maintains for each scheduled dose of a medication a unique serial number per dose. Scheduling is handled by the system, or on a system-related component such as a personal adherence teacher (PAT), described below. This serial number comprises a dose identification number that is defined by the system (in one embodiment, a database assigned incremental integer). The system can cross-reference or find a dose base on that unique serial number. In yet another embodiment, the system uses a combination of a patient or user identification, a prescription or medication identification, and a time/date stamp. In one embodiment, the time/date stamp may be in the format YYY-MM-DD HH:MM:SS.

Outbound adherence related data and information related to a one particular dose that is due to be taken or applied at a particular time comprises a related set of messages (e.g., a series of reminders or alerts) pertaining to that dose. These are matched or paired with serially-related inbound messages (e.g., the patient's response to the outbound messages for that particular dose) to ensure the accuracy of the adherence calculation and determination. It also serves as a safety feature to prevent multiple doses from being taken by the patient in response to multiple or repeated reminders or alerts pertaining to the same scheduled dose.

The sequence of patient adherence behavior activities and events includes, but is not limited to, electronic verification and confirmation of “dose-taken” or “dose-not-taken” behavior with respect to a specific scheduled dose (i.e., the unique serial number for that dose, which may include a time/date stamp as described above). The system also sends, presents, and receives and captures other relevant information that can be correlated with the patient “in-part”, “in-full”, or “not-at-all” response, among other things.

In one exemplary embodiment, the system provides an interactive, personal adherence teacher (PAT) component that may provide an interactive avatar-based interface. The patient or consumer user, working with the PAT component, can populate and complete a medication adherence schedule, which may include daily, monthly, or periodic doses. The system incorporates the particular prescribing instructions written by the prescribing physician, as well as the prescription instructions, warnings, and the like written by the pharmacist, as typically presented to the patient on the prescription label for each medication. The system then assigns the specific unique identifier for each dose of medication going forward, as described above. The schedule may be discussed between the patient and his or her pharmacist at the pharmacy of record, and then entered by the pharmacist into the system with the authorization and consent of the patient.

The system may be used with a variety of medications, regardless of the form of the dose or the package. It can be used for any brand or generic medications, or regimen of medications. In one particular embodiment, each dose of medication then provided by the pharmacist to the patient, if in a solid physical form (e.g., pill or tablet), may be marked with a scannable code (e.g., bar code, QR code, or the like). The user then uses their smart phone, tablet computer, personal computer scanner, or other scanning device to read the scannable code when the dose is taken to confirm that it is the correct medication and to confirm adherence to the schedule, in conjunction with a client program interface to the system (e.g., on a Web browser, smart phone app, or the like). In a further embodiment, the medication container (e.g., bottle) and/or cap is marked with a scannable code (e.g., bar code, QR code, or the like), and is scanned in a similar manner by the patient.

In one exemplary embodiment, the system comprises two prescription medication and identification technologies that utilize smartphone scanning technology combined with information technology and databases to support the electronic digital identification of (i) patient medication prescription bottles or packages via “QRX eLabel” and “QRX eLabel Image Recognition” technology, and (ii) a prescription medication unit dose package or the physical unit dose of a particular medication through the recognition of a fractal algorithmic brand therapeutic generic code mark using corresponding image recognition technology. The two components of each of these two technology sets function as a prescription product-specific “key and lock.” Each lock and key pair can be used or set to function independently or in series with its complementary pair. The functionality and purpose of both technologies fulfill the following operations or functions at the moment in time when a particular dose of a particular medication that is due and is taken by or administered to the patient in accordance with a schedule: (1) establish patient's physical possession of a particular prescription medication package; (2) establish patient's physical possession of a particular prescription medication, i.e., the physical unit dose package or physical dose; (3) assure capture of real-time objective, precise, accurate, and valid prescription medication dose specific adherence data and information; (4) assure data quality and maintain data integrity; (5) confirm the physical location of patient (either by direct entry of location, or the use of GPS or location software) in the patient's device) at the time these activities occur; and (6) confirm with a high degree of precision that administration of a particular dose of a particular medication has occurred and the time and date of that particular dose taken.

Accordingly, the system can capture objective compliance data and related information for medication dose, including, but not limited to, dose taken or not taken, compliance barrier or problem identified by the patient, resolution of the problem or barrier, notifications of barrier or problem sent to physician, pharmacist or care coordinator, the difference in time between time the dose is taken and the time the dose is scheduled, and GPS location upon taking or not taking the dose of medication.

In one exemplary embodiment, the fractal code mark comprises a geometrically unique and reproducible shape comprising three circles, ovals, or lobes, which may be approximately the same size with unique spatial positions (e.g., based on Cartesian coordinates or other coordinate system), as shown in the example below. Some embodiments may also include a triangle or rectilinear shape, as shown. One or more of the circles may contain within its boundary one or more concentric circles (i.e., sharing the same center). Like, the triangle or rectilinear shape may contain one or more concentric triangles or rectilinear shapes. Other small geometric shapes or numbers may be embedded in the code mark. The exemplary shape resembles a geometric shamrock with or without a stem (depending on the presence or absence of the triangle or rectilinear shape). The relative thickness of each curved forming each concentric circle, the relative position of the solid shapes embedded in the geometric shamrock, the relative size of any or all shapes, the colors of all curves, lines and shapes, may vary. The manner and nature of such variation is descriptive of the medication (or object, in the case of a container or package) that it identifies This identification can be used to identify a variety of attributes relating to the medication it identifies, including, but not limited to, brand name, manufacturer, therapeutic class, generic name, dosage strength, batch number, lot number, or control number. The code mark is generated by the system based upon this information, but may include other information in alternative embodiments. The code mark also may be generated as other shapes or images. In various embodiments, the code mark, or other markings or codes, may be used in conjunction with the system to facilitate drug recalls of medications that have already been dispensed (and thereby help prevent their ingestion or use by the patients who have received them), to help prevent medication errors, and to help prevent and detect counterfeit or adulterated medications.

The system may provide encouragement and incentives for compliance by the patient. The system may provide messages to the patient explaining why taking the medicine is important or critical, and provide a compliance rating (which may be in the form of a percentage). The system also may provide appropriate instructions (e.g., do not take with milk), and remind the patient when the medicine is running low, and prompt the patient to order a refill. In yet another embodiment, the system may provide an incentive or reward program (any and all rewards and incentives are provided in accordance with all applicable laws and regulations). The cost of the medicine may be reduced for the patient for enrolling in the system, and discounts may be provided based on enrollment or compliance ratings. In one embodiment, the patient may receive reward points for each time he or she takes a correct dose of medicine on time. Reward points accumulate, and may be used by the patient for discounts, items, or rewards of various sorts.

In several embodiments, the system may further comprise the following components: (1) a dynamic data and information exchange among patients, physicians, pharmacists, health-care professionals, providers, and health coaches to stimulate, reinforce, and measure patient medication adherence behavior and performance (including factors known or thought to play a role contributing to the adoption of positive medication adherence behaviors, habits, and rate), and increase medication adherence performance rates for prescription medications closer to optimal levels as specified by manufacturer dosage and administration guidelines; (2) a compliance effectiveness/efficacy outcome program for optimized medication therapy or adherence behavior optimization, with accompanying applications, to positively impact medication adherence behavior and achieve optimal adherence, as specified by manufacturer dosage and administration guidelines; (3) a user interface, operable via smart phone, personal computer, tablet computer, or mobile computing devices, with gaming elements, to engage the patient or consumer user in adherence behavior; (4) a patient adherence teacher interface with a computer-generated personality or character (e.g., avatar) to engage the patient or consumer user in adherence behavior; (5) a database or data warehouse for storing data generated or input into the system, including compliance or quality assurance information used to conduct the analysis of patient medication adherence behaviors, including statistical analysis and determination of behavior-influencing variables and adherence rates across multiple users and medications; (6) the set of data analysis and reporting tools for such analysis; (7) a report generator for generating a variety of standard or customized reports for the various user groups; and (8) the medication identification technologies described above.

In various embodiments, the system's products, services, applications and solutions are designed to help a variety of health-care organizations study, analyze and examine the correlation between patient medication adherence or compliance, efficacy or effectiveness, and outcomes in real-world and/or research domains. These organizations include, but are not limited to, pharmaceutical manufacturers and businesses, biotechnology companies, pharmacy retailers, payors, PBMs, and provider organizations, including ACOs, HIEs, hospitals, and other health provider systems.

In one exemplary embodiment, the system thus provides real-world patient medication adherence data that is quality assured and authenticated through the system. It validates key medication adherence information at the point of medication administration, including (1) medication identification, (2) dose verification, (3) dosage (e.g., strength, form, frequency), (4) adherence results, and (5) patient attestation of authenticity of results, with permission to correlate adherence data and information with medication efficacy and patient outcomes data.

The system's data warehouse comprises numerous data elements useful in studying, analyzing and identifying correlations between medication adherence behaviors and other elements, such as the effect of co-pay reduction, demographically-relevant rewards, patient education, patient health knowledge testing, social gamification, continuous audio-visual dosing message reminders and alerts, audio-visual dosing and dosage instructions, continuous adherence performance scoring versus targets, the impact of certain adherence barriers on adherence rates, the availability and use of real-time adherence barrier problem solving modalities, the timeliness of the actual dose versus the scheduled dosing time, system notification (to providers, pharmacists, nurses, or health coaches) of patient non-adherence events related to physician-designated “critical medications”, and rewards-driven competition between participants in a social network or employer group.

The components of the system may also be used synchronously to study the effect of increasing or optimizing patient medication adherence behaviors, medication adherence, and medication adherence rates on medication efficacy/effectiveness and outcomes. The system may also be used to study correlations among and between patient medication adherence rates in a research setting or clinical trials, real-world patient medication adherence or compliance rates, and medication efficacy or effectiveness and outcomes, as well as utilization of hospital admissions, emergency room visits, procedures, diagnostic tests, and the like that occur as a result of patient medication non-adherence (and so are potentially avoidable). It should be noted that the term “optimizing” when used in relation to medication adherence or medication adherence rate means optimizing the adherence rate that would be calculated, scored and/or attributed to any patient following manufacturer dosage and administration guidelines for a particular medication.

In several embodiments, data is maintained for each patient for each scheduled dose according to a highly refined indexing protocol such that doses scheduled, doses taken, doses not taken, and related parameters for each scheduled dose for each medication, are all captured by the system. This provides highly specific medication adherence data that can be precisely correlated with dose-specific information and discrete adherence-related factors, events or behaviors. It can also be correlated to other variables related to a specific scheduled dose that is “taken” or “not taken” by the patient.

In one embodiment, a Timed Dose Opportunity Window (“TDOW”) is set for patient responses to messages (i.e., reminders or alerts) that allows for a reasonable time period for the patient to acknowledge receipt of the message, process the dose activities sequence, and send a response System dose data is maintained for each patient according to a highly refined indexing protocol such that actual doses taken or not taken for each scheduled dose for each medication is captured by the system yielding highly specific medication adherence data that can be precisely correlated with dose-specific information pertaining to discrete adherence related factors, events or behaviors, and other variables related to a specific scheduled dose that is “taken” or “not taken” or other, by the patient.

In yet a further embodiment, the system captures and stores patient-level prescription and medication information and creates an electronic cloud-based patient prescription medication record for each patient entered into the system. This record is available around the clock (“24/7”) to the patient as well as pharmacies, physicians, health coaches, and other health care professionals in the patient care chain who are granted secure access by the patient to view limited or comprehensive medication information and/or reports. This information can be used by the patient care chain to review and better understand how medication adherence performance for a particular patient may be positively or negatively impacting medication effectiveness and patient outcomes versus expected results. The prescription medication record for each patient also may be useful in aligning prescription refill dates and conducting medication reconciliation in a variety of settings across the continuum of care. Reports and tools are web-based, patient secured and HIPAA secure so that physicians can access patient level information prior to or during scheduled patient visits so that the data and information regarding a patient's adherence performance, variation by patterns by medication, dosing schedule, and patient-reported adherence barriers and system-proposed solutions can be reviewed and discussed with the patient. The system also offers a comprehensive set of automated reports available by subscription to providers who wish to study medication adherence patterns of their patient population in greater detail and explore correlations or patterns among variables that may affect medication adherence, medication adherence behaviors, or medication adherence rates.

The information stored in the system includes patient demographics, and detailed contact information for pharmacy of record and pharmacist(s), primary care physicians, specialists, physician extenders such as nurse practitioners or physician assistants, and health coaches. It also may include detailed prescription information including name of each medication, prescribing physician, dosage instructions, medication description and image, dates prescription initially filled, refill and patient pickup or delivery dates; number of doses dispensed, special instructions such as cautions and warnings, patient insurance information, and detailed and redundant digital and electronic contact information for each patient (including primary and secondary mobile phone number, text address, email address). Similar contact information for each patient's designated health coach and certain designated physicians or their practice designees (such as a nurse, nurse practitioner or physician assistant, or care coordinator, who is an authorized user of the system and granted access to certain information as approved by one or more patients) may be maintained. The system also includes system user documents, waivers and releases in relation to respective responsibilities of pharmacy, pharmacist, prescribing physicians, limitation of liability; and HIPAA authorizations, as well as patient certificate of compliance program authorization, enrollment and acknowledgement data by patient and pharmacist (including attestations of accuracy of information and acknowledgement that use of the system to achieve financial benefits such as co-pay reductions or rewards by entering false information is a violation of law and may constitute insurance fraud or a felony offense punishable by fines and jail sentence), HIPAA policy review, all appropriate waivers, releases, and authorizations, as well as a repository of all required signatures in electronic format.

In several exemplary embodiments, the system communicates with the patient on a secure two-way around-the clock (“24/7”) real-time basis via smartphone, desktop personal computer, tablet computer, or other mobile device. It provides medication dosing reminders and alerts, adherence barrier solutions, adherence performance scores, and continuous updates regarding co-pay dollars and rewards points earned versus potential. The system also communicates multi-directionally (i.e., to more than one user group) on a similar real-time basis with healthcare professionals or a health coach approved by the patient (based on options selected and authorized by the patient and with the agreement of any third party, such as the healthcare professional or health coach).

The system also can operate in a disconnected mode, where the user device is not connected to the main system data centers (which can result from a variety of reasons, technical or operational). In disconnected mode, the local program stores adherence information, date/time stamps, GPS coordinates, and any other relevant data locally on the user's device. This information is then sent to the system data centers (e.g., in the cloud) when communications are restored, thereby causing the system to update and sync the adherence and medication data.

The system continuously calculates overall and medication-specific patient adherence rates for individual patient members of the system by comparing a particular patient's time- and date-stamped medication-specific response to a particular time- and date-stamped medication-specific dose reminder and alert. The system also captures and stores the time and date of missed doses by medication as well as the primary reason the patient reports for having missed a particular dose. The system also proposes issue-specific solutions to each medication adherence barrier the patient reports for a particular dose of a medication. The system calculates and maintains accurate medication adherence rates, time-to-dose statistics, primary reason(s) for a particular missed dose(s), adherence solutions proposed by the system, patient response and correlating adherence result, and the specific description of any side effects reported by the patient with a particular medication. Certain medications for which medication non-adherence is associated with high-risk consequences based on medication or medical condition or disease state may be designated as “Critical Medications.”

In further embodiments, compliance certification is provided by the system, such as the determination of adherence scores. The system may seek waivers from patients to examine claims for emergency room visits, hospital admissions, test, procedures, and the like. Patients may receive premium or co-pay reductions, as well as other incentives offered by an insurer or plan.

### BRIEF DESCRIPTION OF THE DRAWINGS

FIG. 1A shows an example of a system application icon on a mobile device in accordance with an embodiment of the present invention.

FIG. 1B shows an example of a system alert for a mobile device application.

FIG. 2 shows an example of a login screen for a mobile device application.

FIGS. 3A-B show examples of a main menu for a mobile device application.

FIG. 4A shows an example of an active medication list for a mobile device application.

FIG. 4B shows an example of a medication action screen for a mobile device application.

FIG. 5A shows an example of a take medication screen for a mobile device application.

FIG. 5B shows an example of a scan medication screen for a mobile device application.

FIG. 5C shows an example of a confirm intake screen for a mobile device application.

FIG. 6 shows an example of a login screen for a web-based application.

FIG. 7 shows an example of an alerts screen.

FIG. 8 shows an example of a selected medication detail screen.

FIG. 9 shows an example of a taking medication confirmation screen.

FIG. 10 shows an example of a not taking medication confirmation screen.

FIG. 11 shows an example of a medication information screen.

FIG. 12 shows an example of a main patient dashboard.

FIG. 13 shows an example of a “MyDailyMeds” screen.

FIG. 14 shows an example of a “MyRefills” screen.

FIG. 15 shows an example of a “MyPharmacy” screen.

FIG. 16 shows an example of a “MyPhysicians” screen.

FIG. 17 shows an example of a change medications prompt.

FIG. 18 shows a diagram of patient flow for an exemplary embodiment of the present invention.

FIG. 19 shows an example of an insurance card with a system logo.

FIG. 20 shows an example of a prescription label with system information.

FIG. 21 shows an example of a fractal code mark.

### DETAILED DESCRIPTION OF EXEMPLARY EMBODIMENTS

In various exemplary embodiments, the present invention comprises a system and related methods for improving and sustaining patient adherence, compliance and persistence with a medication plan, regimen or regime (any reference to the terms adherence, compliance and persistence herein, individually or in combination, should be construed to encompass all three terms). The system may work with a particular prescription medication or medications, or for a daily or periodic regimen of multiple prescription medications.

The system promotes adherence behavior by patients, and increases medication adherence performance and rates. It continuously initiates, stimulates, motivates, educates, instructs, guides, reinforces and rewards compliant behavior by patients through a variety of means described herein. It thus provides quality-assured patient self-administration of medication at the correct point in time for each scheduled medication dose. Further, the system provides real-time dosing alerts and adherence results, provides real-time problem solving for non-compliant behavior, coordinates with physicians and other healthcare providers, and overcomes behavioral, clinical and cost barriers to medication compliance.

In one embodiment, the system comprises a centralized or “cloud-based” network accessible through the Internet, or a public or private network. Users may access the system through a Web browser, an application program on a smart phone, tablet computer, or other mobile computer device, or a dedicated computing device or service.

In one exemplary embodiment, the system supports instantaneous exchange and storage of adherence related data and information among and between various users of the system, including, but not limited to, consumers, patients, providers, health-care professionals (e.g., physicians, nurse practitioners, physician assistants, case managers, discharge planners, care coordinators, health coaches, and pharmacists) insurers, and system administrators. Access is limited to those authorized to receive information from the system by the corresponding patient or consumer user, pursuant to HIPAA and other applicable regulatory guidelines or rules.

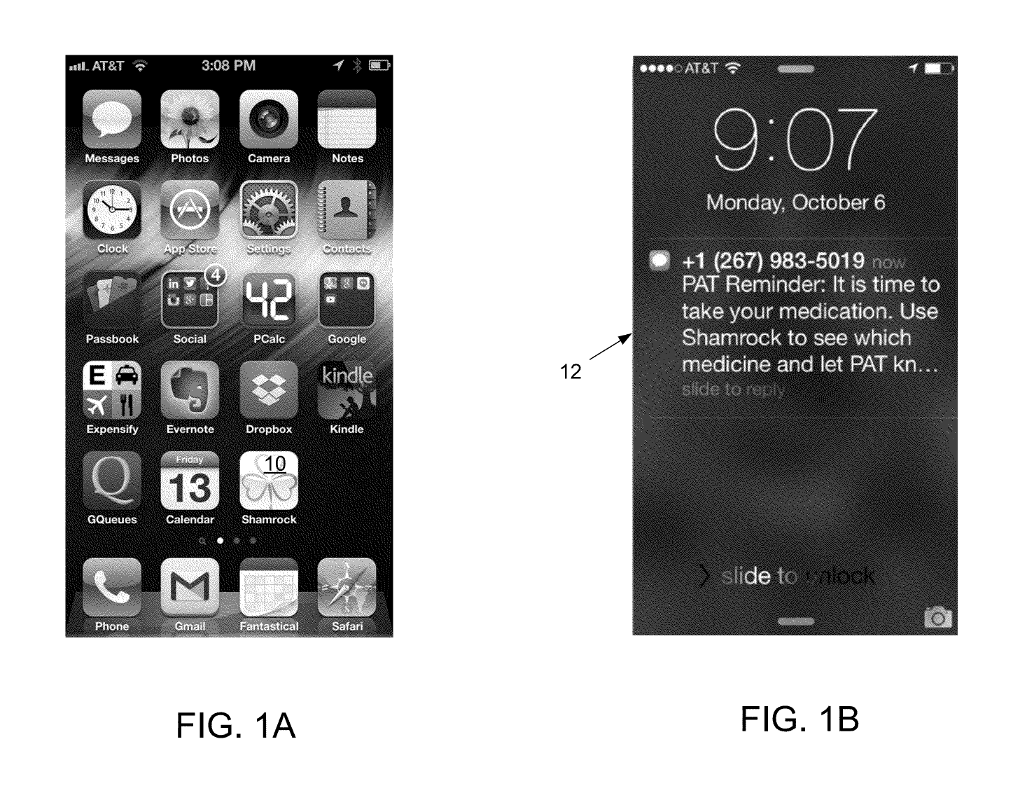

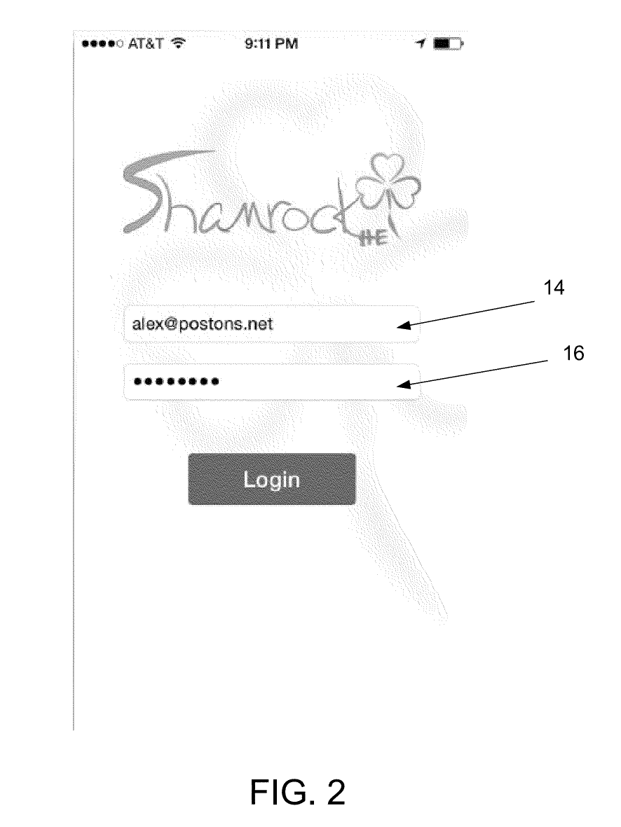

FIGS. 1-17 show a variety of user interface screens on a mobile device or a web browser for a user who is a patient. FIG. 1A shows a user program for the present invention loaded as an application 10 on a smart phone or similar mobile device. The application can be opened by selecting the icon 10, but it also can run in the background and send reminder alerts 12 in a timely manner, as seen in FIG. 1B. If the application is opened, the user is prompted to log in, as seen in FIG. 2. While this screen shows the user logging in with a user name 14 and password 16, other means to ensure user identity and provide security (such as biometrics) may be used.

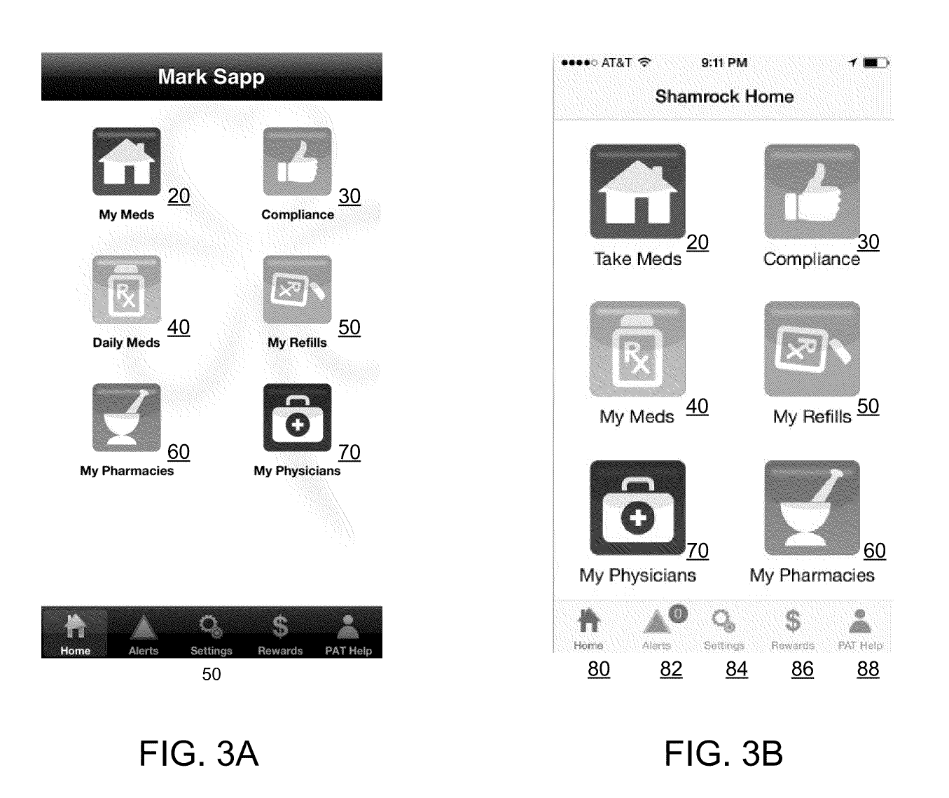

Upon logging in, the user is presented with a home screen, examples of which are seen in FIGS. 3A and 3B. From here, the user can choose a variety of options from the menu: Take Meds/My Meds 20; Compliance 30; My Meds/Daily Meds 40; My Refills 50; My Pharmacies 60; and My Physicians 70. The user also can select from a variety of options from a menu along the bottom of the screen: Home (to come back to the home page) 80; Alerts (which may have a number or signal indicating if there are any current alerts) 82; Settings (to modify program settings) 84; Rewards 86, and PAT Help 88.

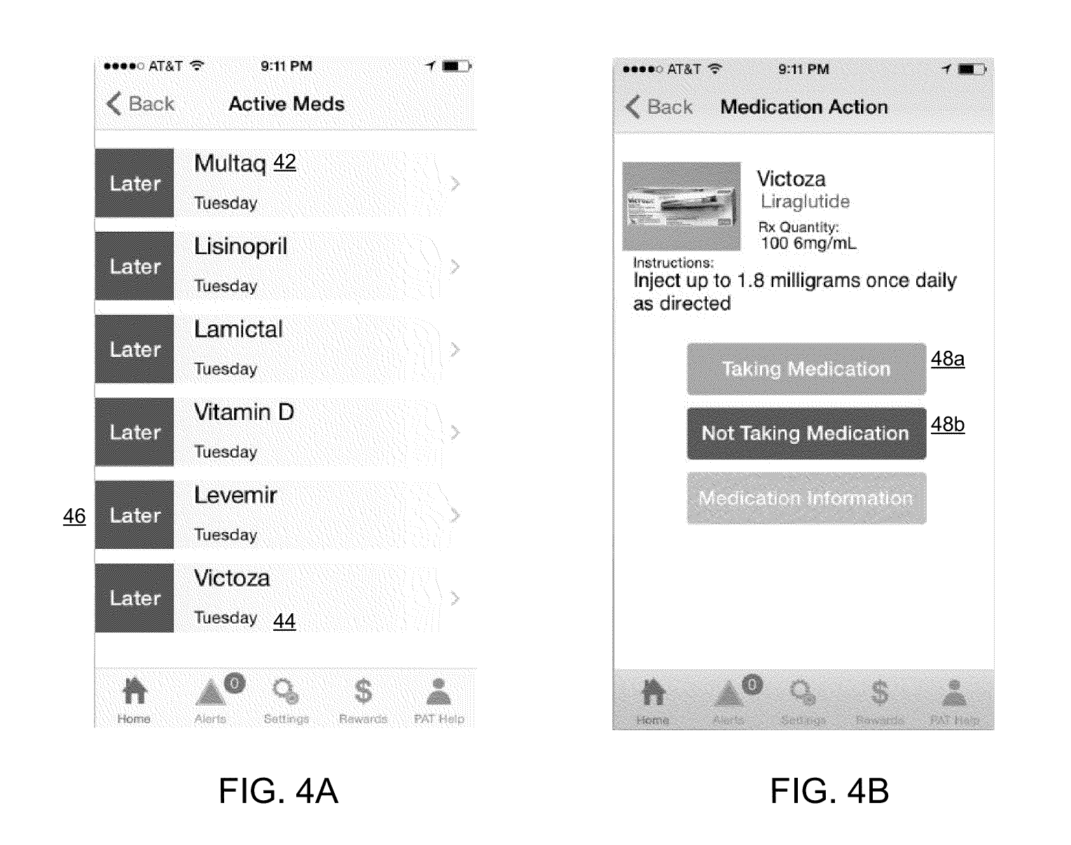

Upon choosing the Take Meds/My Meds/Daily Meds options, the user is presented with a screen listing the active medications to be taken by the user on a schedule, as seen in FIG. 4A. The list is provides a common name 42 for each medicine, and a day and/or time for taking the medicine dose (e.g., Tuesday, 7:00 am, 6:00 pm) 44, and an indicator of whether the medicine dose is currently due or due later (i.e., “Due”, “Later”) 46.

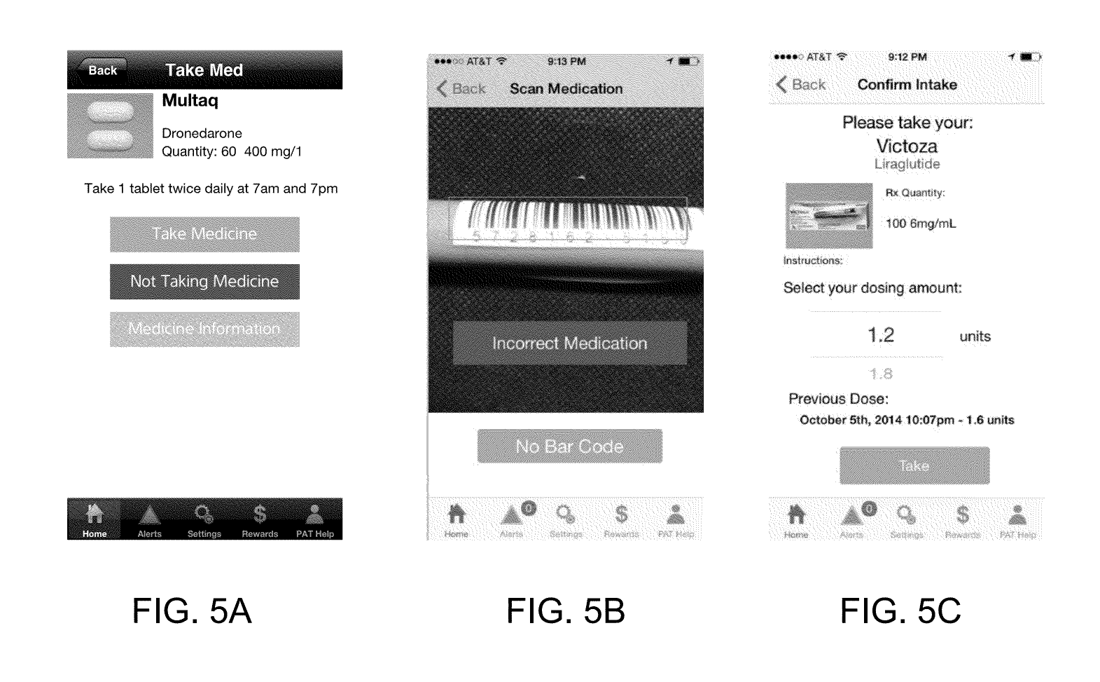

Upon selecting a particular medicine, the user is presented with the medication action (or take medicine) screen, as seen in FIGS. 4B and 5A. This screen contains a more detailed description of the medicine and instructions for how to take it. The user can go back to the medicine list, can request additional medication information, or can elect to take 48a or not take 48b the medication.

Upon electing to take the medication, the user is prompted to scan a code on the medication label to confirm whether that the correct medicine is being taken. The program will indicate if the code does not match with an “Incorrect Medication” warning or alert, as seen in FIG. 5B. If there is no code, the user can indicate that by selecting the “No Code” or “No Bar Code” option. The application will then bypass the scanning step, or will ask the user to separately verify the medication label.

FIG. 5C shows a confirmation screen for taking the medicine. It indicates the amount of the recommended dose, but allows the user to input a different dosing amount. It also may provide information on the last dose taken. The user then takes the medication and indicates this by selecting the “Take” button. If the user elects not to take the medicine, they are prompted to provide a reason for not doing so. If the user selects the option to obtain more information about the medication, they are provided with that more detailed information with an overview, listing of side effects, and interactions.

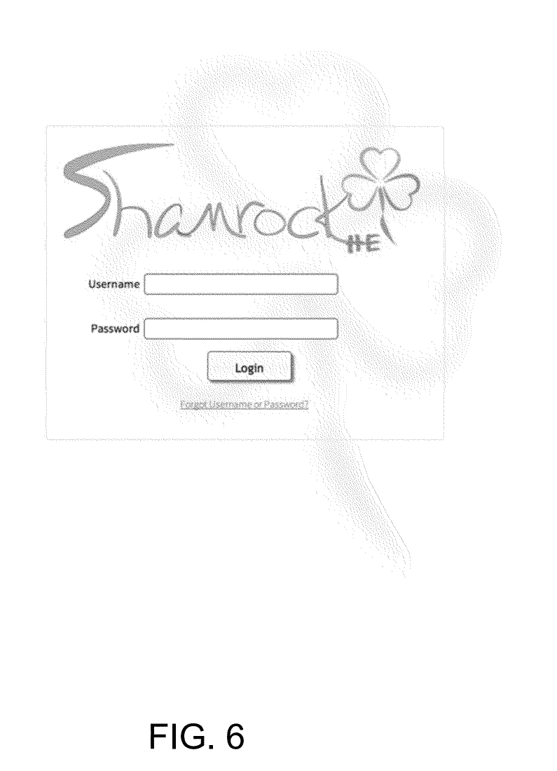

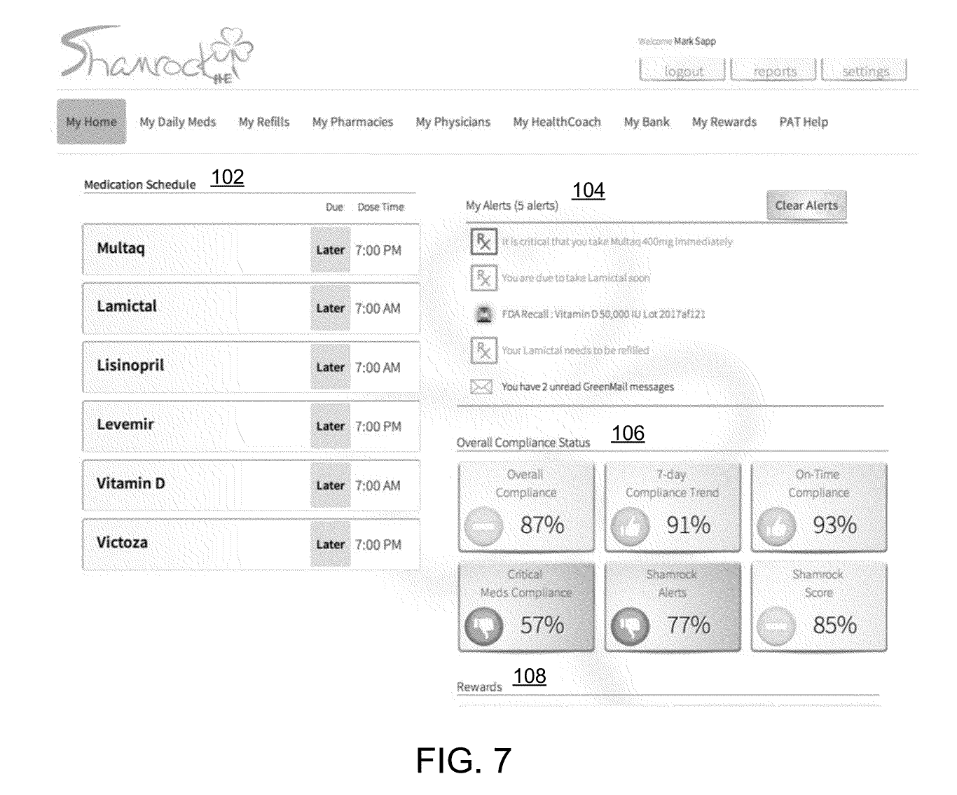

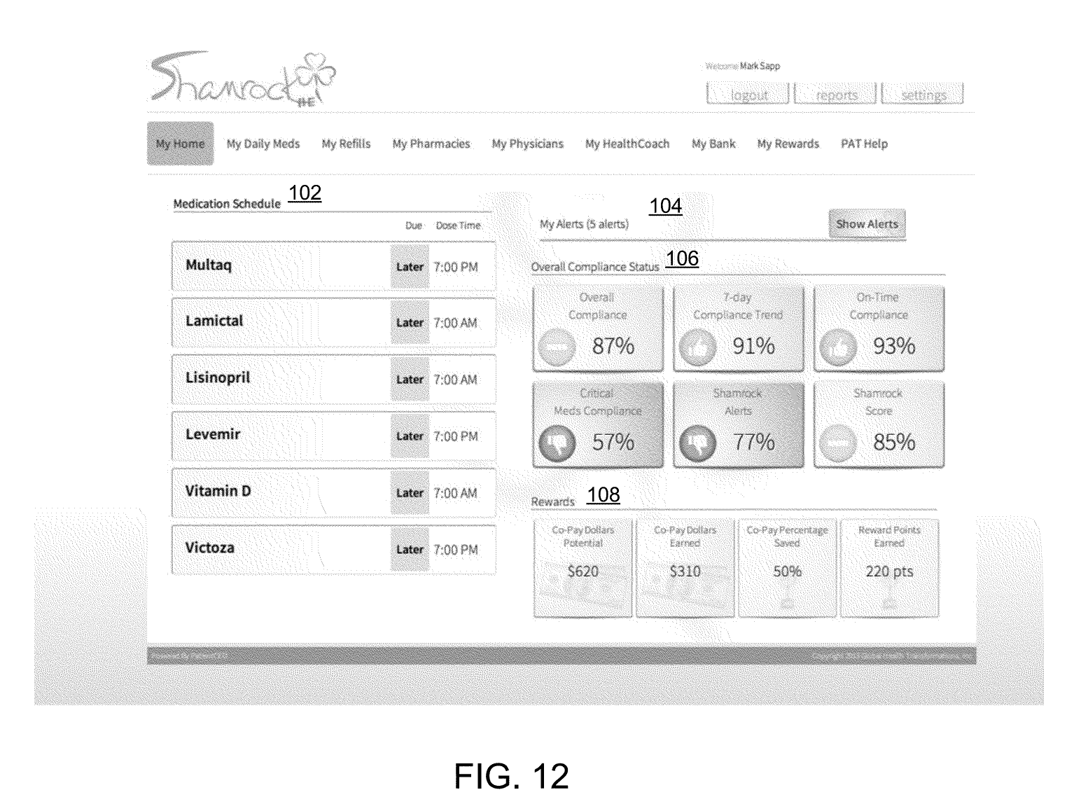

The screens for a web-browser based version of the patient program are similar. FIG. 6 shows a login screen for a patient using a browser on a personal computer or similar computing device. FIG. 7 shows the home page, where the user is provided with a medication schedule listing 102, a listing of alerts 104, a compliance status summary table 106, and reward summary 108. FIG. 12 shows another embodiment of the home page. The medication schedule listing provides a summary list of medication name, due status, and dose date/time. The alerts listing indicates whether certain actions need to be taken, and how quickly. These may be color-coded (e.g., red for a critical alert). It also may provide information about a variety of medication-related incidents, such as FDA recalls. The compliance status summary table provides a numerical or percentage score to indicate the user's compliance ratings or status for a variety of measures (e.g., overall compliance, 7-day compliance trend, on-time compliance, critical medications compliance, number of system (Shamrock) alerts, comprehensive system (Shamrock) compliance score). Color (green, yellow, red) and/or indicators (thumbs-up, thumbs-down, plus, minus) may be used to provide visual indications of whether each particular rating or score is good, okay, or needing improvement.

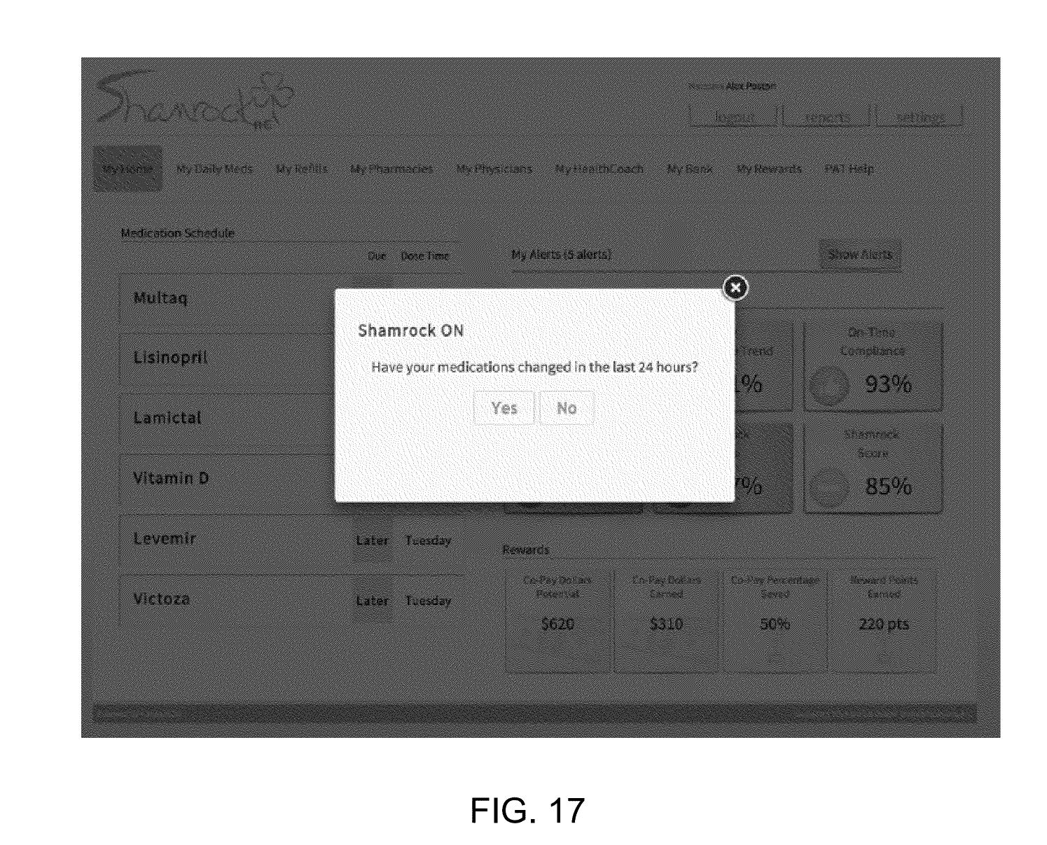

The system at certain points (such as login, or one a day) may ask the user if their medications have changed, as seen in FIG. 17. If so, the user will be led through the steps to add any new medications, or modify any existing medications in their list. A notification may be sent to the system call center (as described below) to schedule a time to update the information. If not, the application proceeds according to the schedule.

From the home page, the user can, in a similar manner to the mobile-based application, navigate to a variety of sub-pages in the application by means of tabs: My Daily Meds; My Refills; My Pharmacies; My Physicians; My HealthCoach; MyBank; MyRewards; PAT Help.

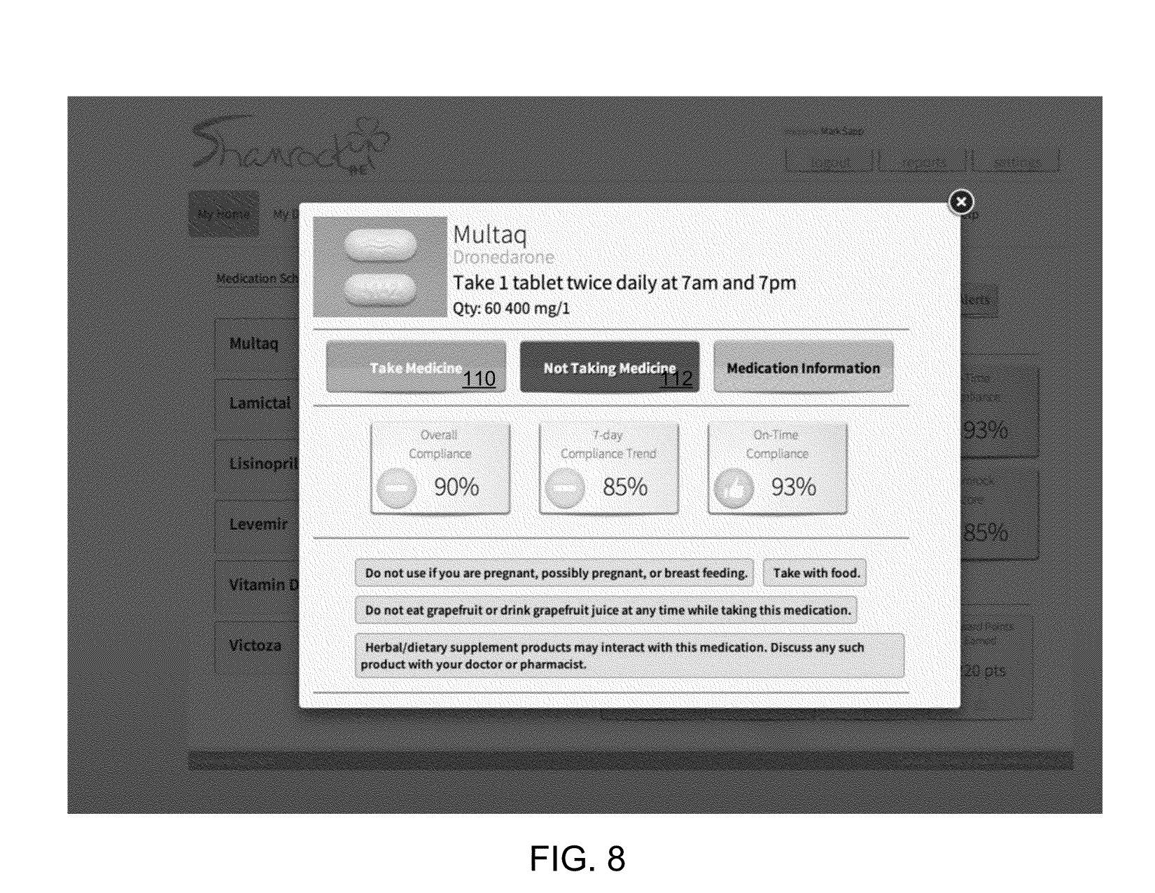

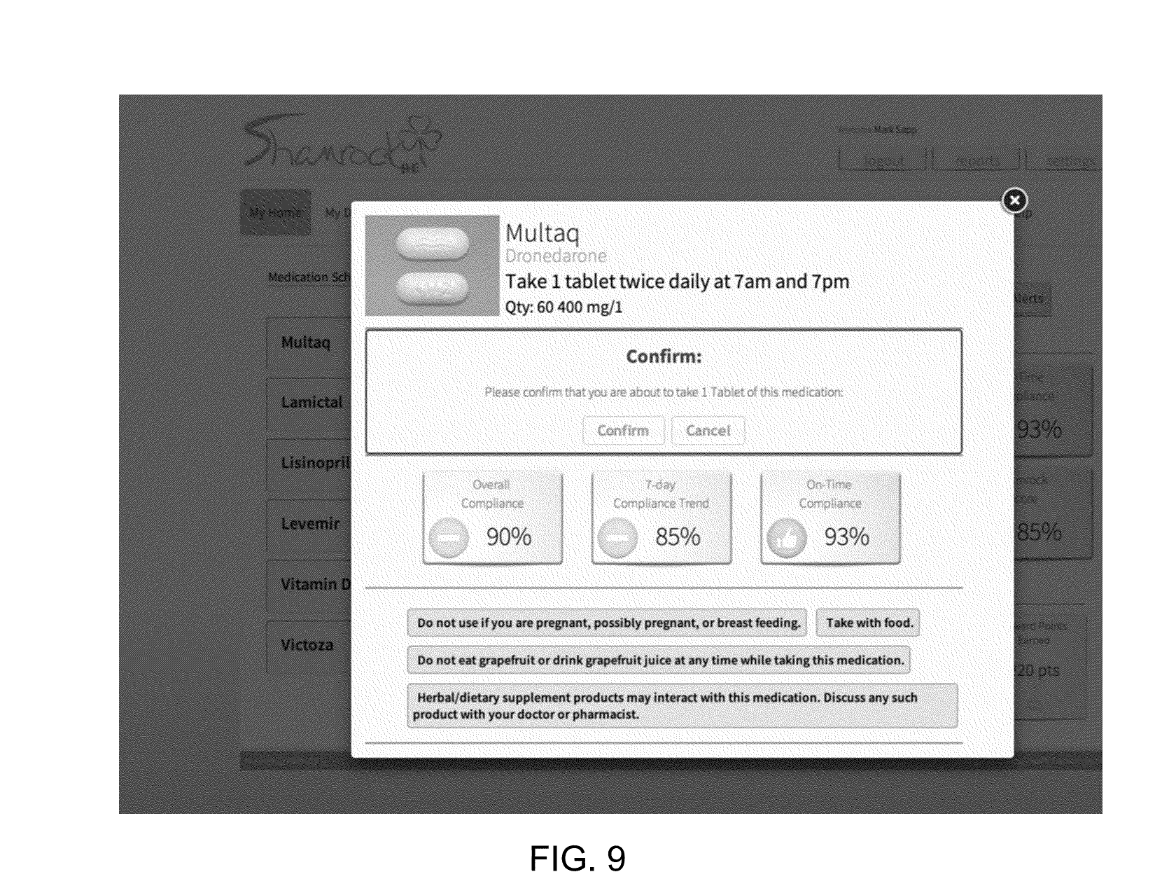

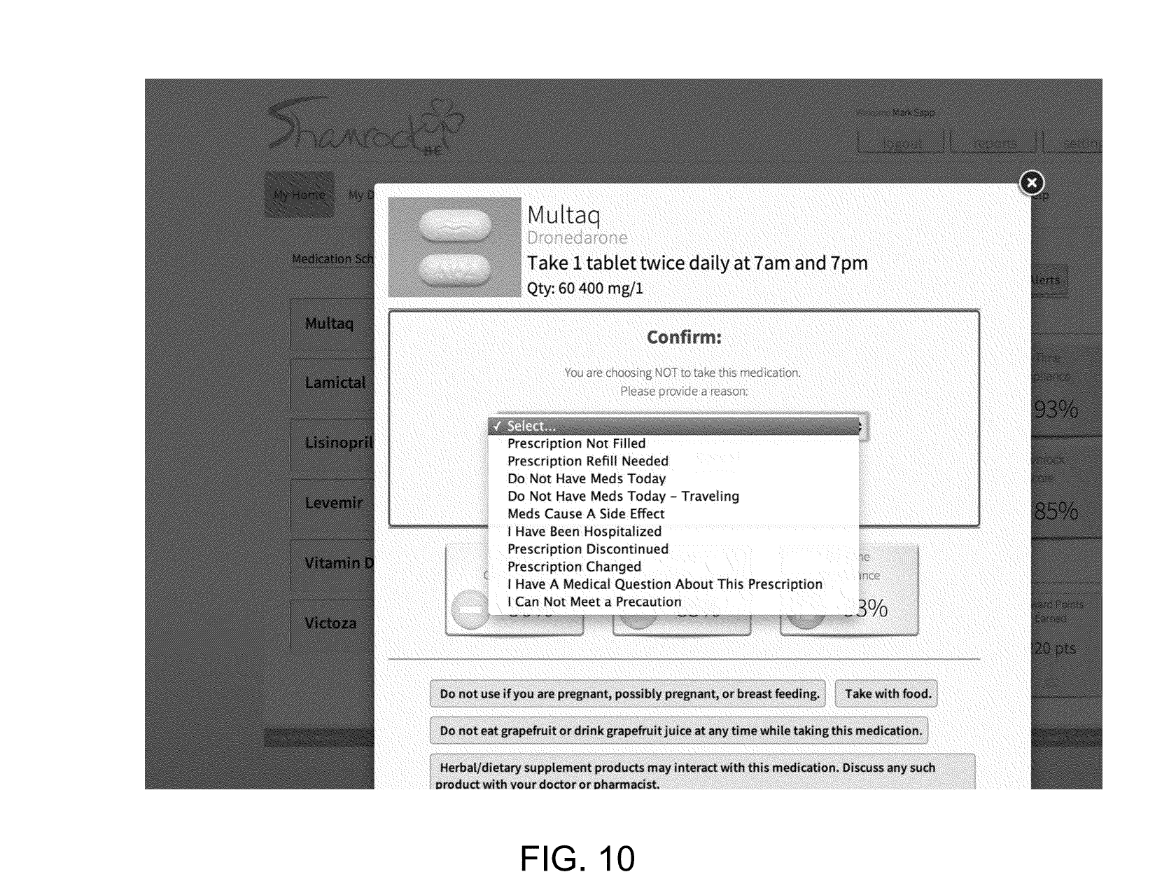

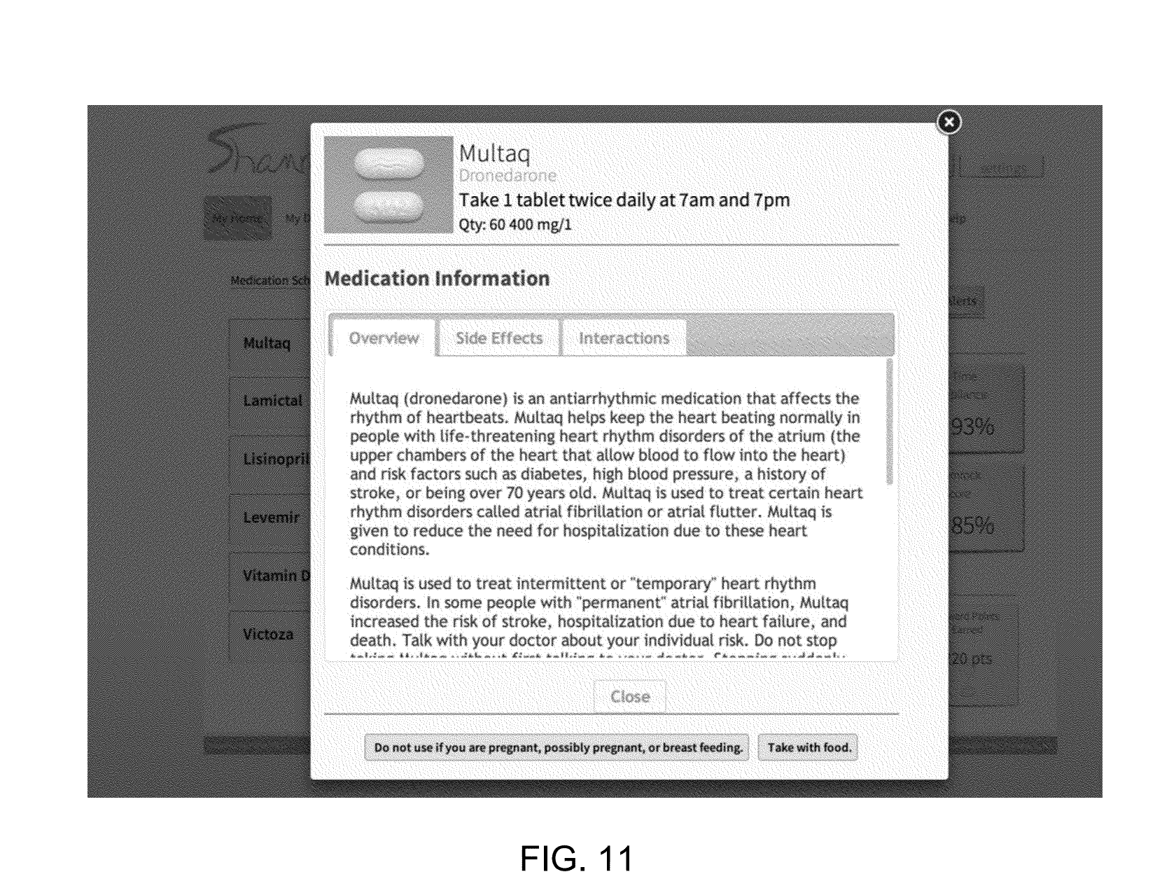

Upon selecting a particular medicine from the medication schedule listing, the user is presented with a detailed medication screen as seen in FIG. 8. This includes more information about the medicine, instructions and warnings, compliance trends and ratings for that particular medication, and options to obtain more medication information, or take 110 or not take 112 the medicine. If the user elects to take the medicine, they are prompted to confirm doing so, as seen in FIG. 9. A “good job” message may be provided upon confirmation to reinforce compliance. If the user elects not to take the medicine, they are prompted to provide a reason for not doing so, as seen in FIG. 10. If the user selects the option to obtain more information about the medication, they are provided with that more detailed information with an overview, listing of side effects, and interactions, as seen in FIG. 11.

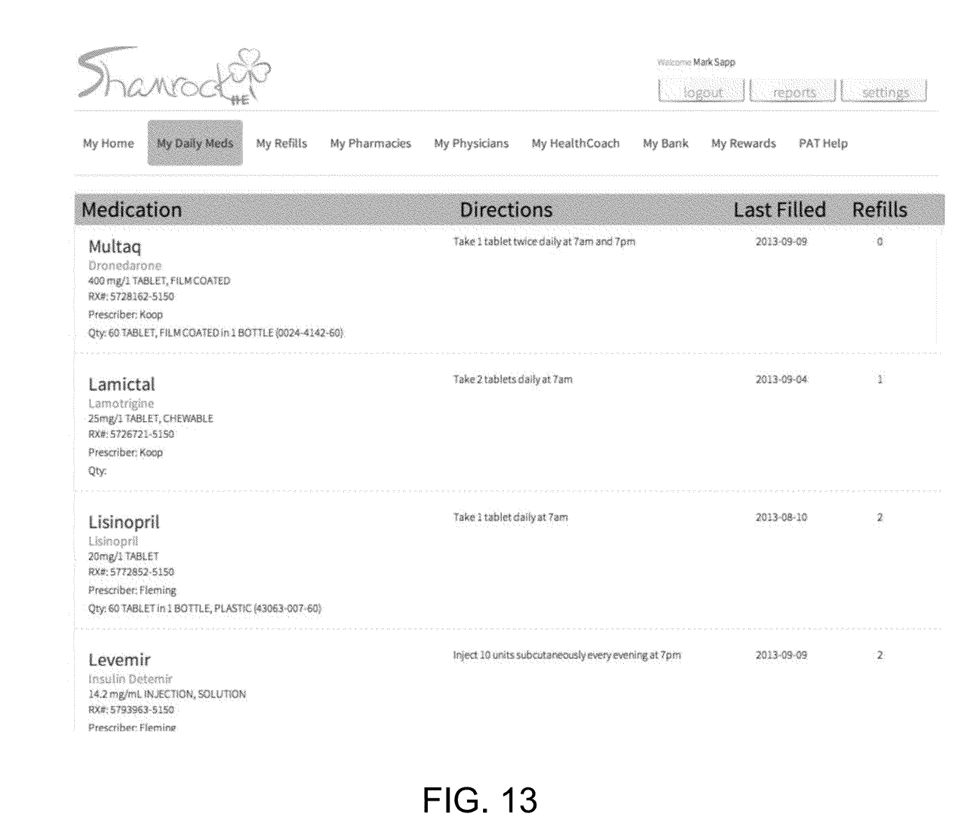

FIG. 13 shows an example of a “My Daily Meds” screen. This shows details about the medication (e.g., name, dose, form, RX number, prescriber, amount and form of prescription), directions, date the prescription was last filled, and number of refills remaining. Other information may be shown.

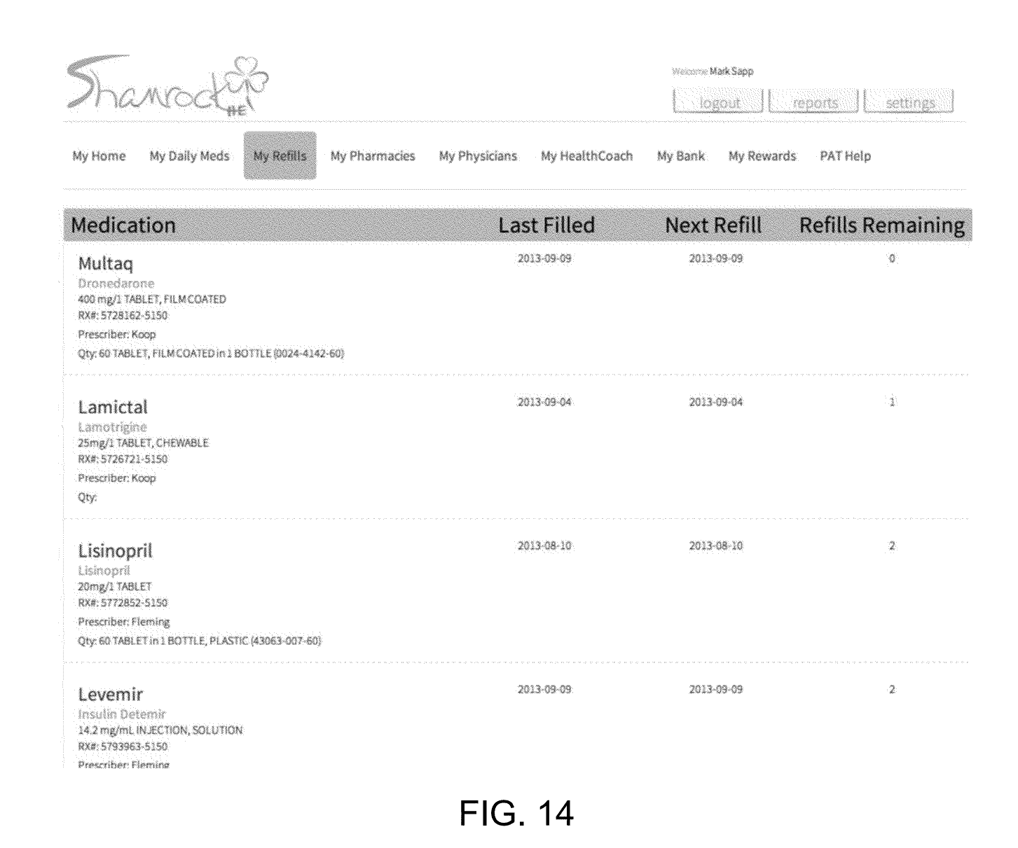

FIG. 14 shows an example of a “My Refills” screen. This shows details about the medication (as in FIG. 13), date the prescription was last filled, date of the next refill, and number of refills remaining.

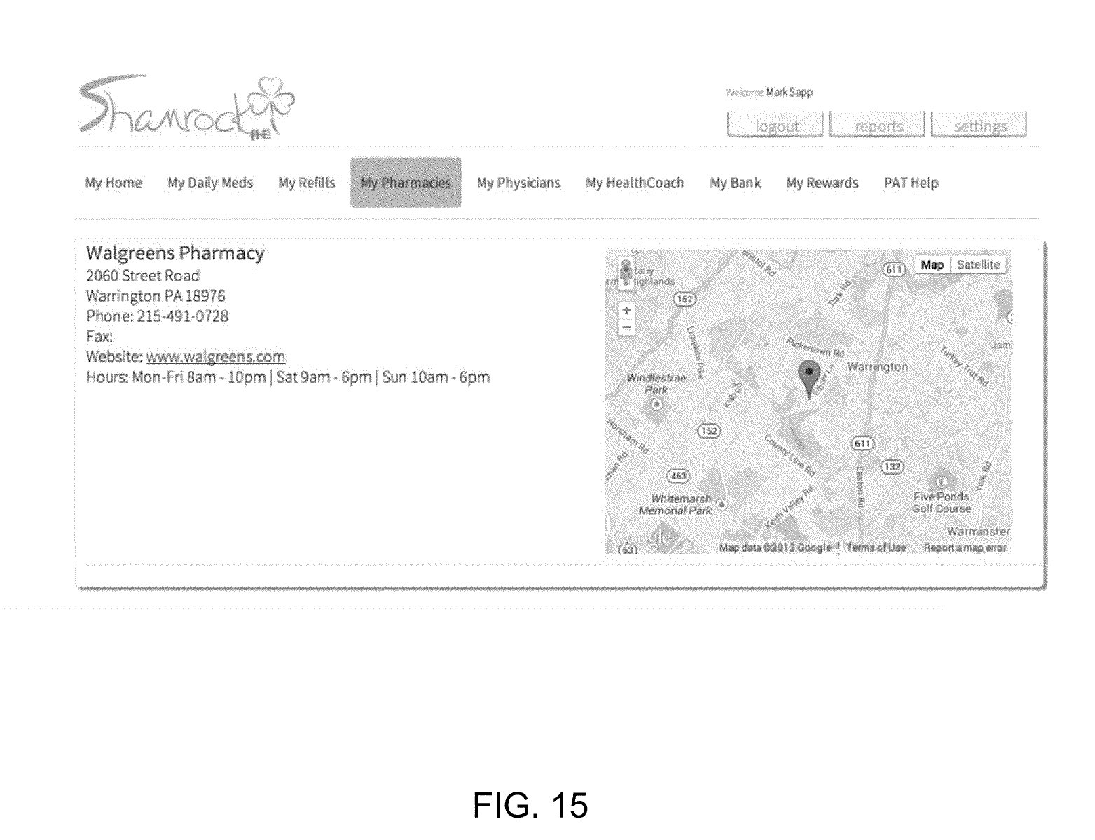

FIG. 15 shows an example of a “My Pharmacies” screen. This provides various details about the name and location of one or more pharmacies used by the patient, and may include a map for each showing the location thereof.

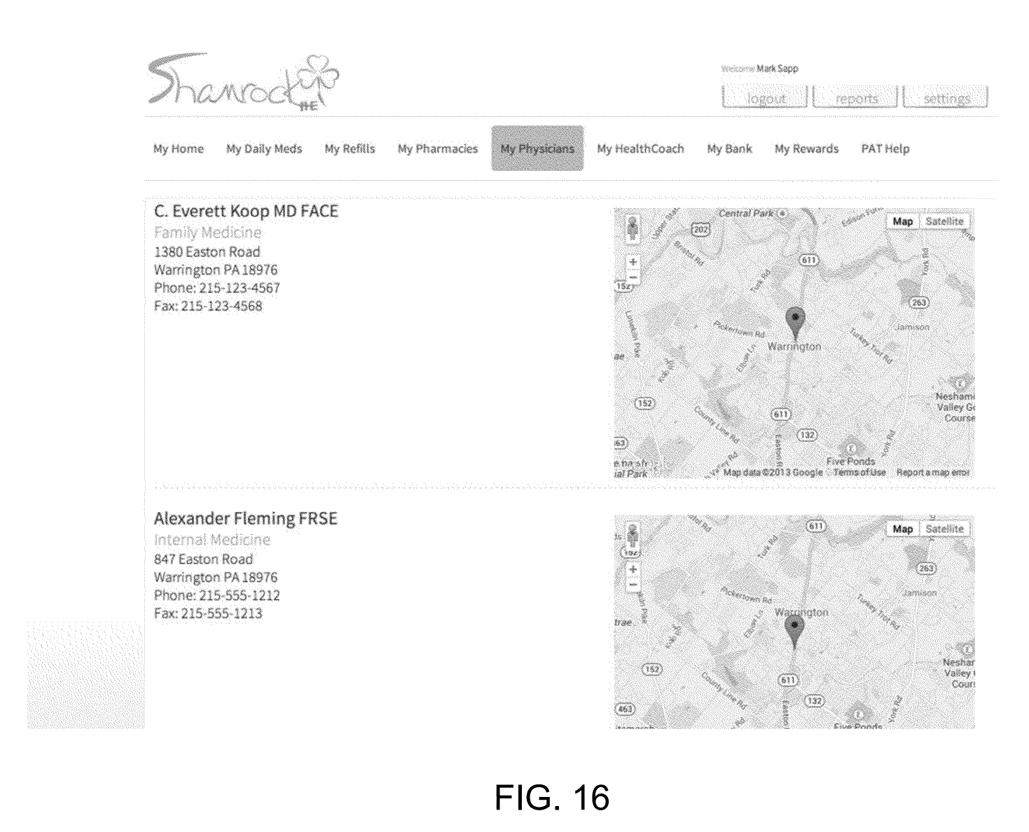

FIG. 16 shows an example of a “My Physicians” screen. This provides various details about the name and location of one or more physicians used by the patient, and may include a map for each showing the location thereof.

While several of the above screens and descriptions have been provided for a mobile-based application or a web-based applications, it is understood that screens and descriptions applicable to one form also are application to other forms.

In several embodiments, adherence-related data and information comprises outbound and inbound messages. Outbound messages are sent by the system to a patient, consumer, or other user. Inbound messages are sent to the system by patient, consumer, or other source. In one embodiment, the messages are in digital electronic form, serially identifiable, discrete, and may be medication-specific and dose-specific. In one form, the messages are time-stamped and date-stamped patient engagement messages, with the primary purpose and function to stimulate or help initiate a certain sequence of patient adherence behavior activities or events, or a combination thereof, by the patient or consumer user. Inbound messages from the patient or consumer user provide data and information that validates whether some or all of that sequence of patient adherence behavior activities or events have been carried out by the patient. Compliance can be indicated as “in-part”, “in-full”, or “not-at-all.”

In one particular embodiment, the system assigns and maintains for each scheduled dose of a medication a unique serial number per dose. Scheduling is handled by the system, or on a system-related component such as a personal adherence teacher (PAT), described below. This serial number comprises a dose identification number that is defined by the system (in one embodiment, a database assigned incremental integer). The system can cross-reference or find a dose base on that unique serial number. In yet another embodiment, the system uses a combination of a patient or user identification, a prescription or medication identification, and a time/date stamp. In one embodiment, the time/date stamp may be in the format YYY-MM-DD HH:MM:SS.

Outbound adherence related data and information related to a one particular dose that is due to be taken or applied at a particular time comprises a related set of messages (e.g., a series of reminders or alerts) pertaining to that dose. These are matched or paired with serially-related inbound messages (e.g., the patient's response to the outbound messages for that particular dose) to ensure the accuracy of the adherence calculation and determination. It also serves as a safety feature to prevent multiple doses from being taken by the patient in response to multiple or repeated reminders or alerts pertaining to the same scheduled dose.

The sequence of patient adherence behavior activities and events includes, but is not limited to, electronic verification and confirmation of “dose-taken” or “dose-not-taken”behavior with respect to a specific scheduled dose (i.e., the unique serial number for that dose, which may include a time/date stamp as described above). The system also sends, presents, and receives and captures other relevant information that can be correlated with the patient “in-part”, “in-full”, or “not-at-all” response, among other things.

In one exemplary embodiment, the system provides a personal adherence teacher (PAT) component that may provide an avatar-based interface. The patient or consumer user, working with the PAT component, can populate and complete a medication adherence schedule, which may include daily, monthly, or periodic doses. The system incorporates the particular prescribing instructions written by the prescribing physician, as well as the prescription instructions, warnings, and the like written by the pharmacist, as typically presented to the patient on the prescription label for each medication. The PAT component may also be used to provide reminders with third-party intervention agents, including, but not limited to, a health coach, medical office, physician, or the like.

Automated communication functions are executed through a rules engine, and dose reminders (and other communications) are sent by text, email or phone call (such as through the PAT avatar) to the patient.

The system assigns the specific unique identifier for each dose of medication going forward, as described above. The schedule may be discussed between the patient and his or her pharmacist at the pharmacy of record, and then entered by the pharmacist into the system with the authorization and consent of the patient.

The system may be used with a variety of medications, regardless of the form of the dose or the package. It can be used for any brand or generic medications, or regimen of medications.

In one particular embodiment, each dose of medication then provided by the pharmacist to the patient, if in a solid physical form (e.g., pill or tablet), may be marked with a scannable code (e.g., bar code, QR code, or the like). The user then uses their smart phone, tablet computer, personal computer scanner, or other scanning device to read the scannable code when the dose is taken to confirm that it is the correct medication and to confirm adherence to the schedule, in conjunction with a client program interface to the system (e.g., on a Web browser, smart phone app, or the like). In a further embodiment, the medication container (e.g., bottle) and/or cap is marked with a scannable code (e.g., bar code, QR code, or the like), and is scanned in a similar manner by the patient.

In one exemplary embodiment, the system comprises two prescription medication and identification technologies that utilize smartphone scanning technology combined with information technology and databases to support the electronic digital identification of (i) patient medication prescription bottles or packages via “QRX eLabel” and “QRX eLabel Image Recognition” technology, and (ii) a prescription medication unit dose package or the physical unit dose of a particular medication through the recognition of a fractal algorithmic brand therapeutic generic code mark using corresponding image recognition technology. The two components of each of these two technology sets function as a prescription product-specific “key and lock.” Each lock and key pair can be used or set to function independently or in series with its complementary pair. The functionality and purpose of both technologies fulfill the following operations or functions at the moment in time when a particular dose of a particular medication that is due and is taken by or administered to the patient in accordance with a schedule: (1) establish patient's physical possession of a particular prescription medication package; (2) establish patient's physical possession of a particular prescription medication, i.e., the physical unit dose package or physical dose; (3) assure capture of real-time objective, precise, accurate, and valid prescription medication dose specific adherence data and information; (4) assure data quality and maintain data integrity; (5) confirm the physical location of patient (either by direct entry of location, or the use of GPS or location software) in the patient's device) at the time these activities occur; and (6) confirm with a high degree of precision that administration of a particular dose of a particular medication has occurred and the time and date of that particular dose taken.

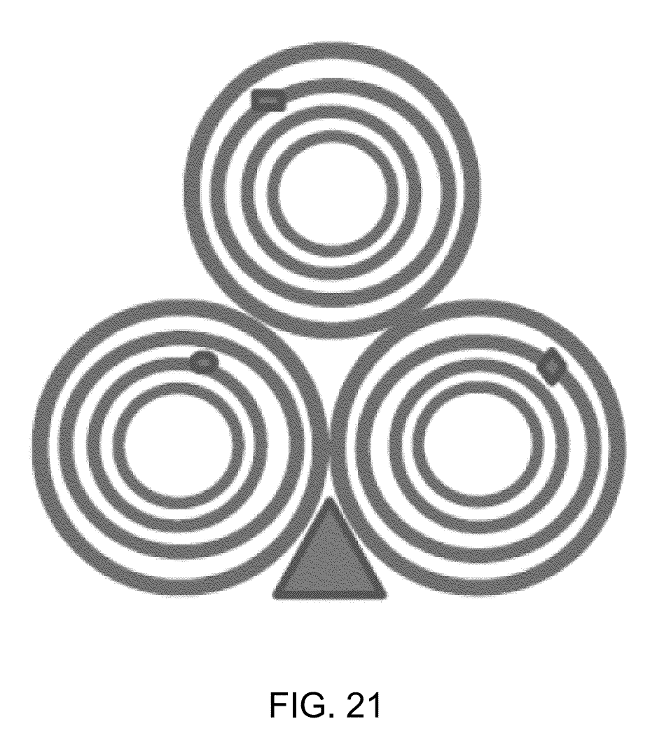

In one exemplary embodiment, the fractal code mark comprises a geometrically unique and reproducible shape comprising three circles, ovals, or lobes, which may be approximately the same size with unique spatial positions (e.g., based on Cartesian coordinates or other coordinate system), as shown in FIG. 21. Some embodiments may also include a triangle or rectilinear shape, as shown. One or more of the circles may contain within its boundary one or more concentric circles (i.e., sharing the same center). Like, the triangle or rectilinear shape may contain one or more concentric triangles or rectilinear shapes. Other small geometric shapes or numbers may be embedded in the code mark. The exemplary shape resembles a geometric shamrock with or without a stem (depending on the presence or absence of the triangle or rectilinear shape). The relative thickness of each curved forming each concentric circle, the relative position of the solid shapes embedded in the geometric shamrock, the relative size of any or all shapes, the colors of all curves, lines and shapes, may vary. The manner and nature of such variation is descriptive of the medication (or object, in the case of a container or package) that it identifies This identification can be used to identify a variety of attributes relating to the medication it identifies, including, but not limited to, brand name, manufacturer, therapeutic class, generic name, dosage strength, batch number, lot number, or control number. The code mark is generated by the system based upon this information, but may include other information in alternative embodiments. The code mark also may be generated as other shapes or images.

In various embodiments, the code mark, or other markings or codes, may be used in conjunction with the system to facilitate drug recalls of medications that have already been dispensed (and thereby help prevent their ingestion or use by the patients who have received them), to help prevent medication errors, and to help prevent and detect counterfeit or adulterated medications.

The system may provide encouragement and incentives for compliance by the patient. The system may provide messages to the patient explaining why taking the medicine is important or critical, and provide a compliance rating (which may be in the form of a percentage). The system also may provide appropriate instructions (e.g., do not take with milk), and remind the patient when the medicine is running low, and prompt the patient to order a refill. In yet another embodiment, the system may provide an incentive or reward program (any and all rewards and incentives are provided in accordance with all applicable laws and regulations). The cost of the medicine may be reduced for the patient for enrolling in the system, and discounts or rebates may be provided based on enrollment or compliance ratings. Information about discounts or rebates may be provided to the patient through the application as part of the medication information. In one embodiment, the patient may receive reward points for each time he or she takes a correct dose of medicine on time. Reward points accumulate, and may be used by the patient for discounts, items, or rewards of various sorts.

In several embodiments, the system may further comprise the following components: (1) a dynamic data and information exchange among patients, physicians, pharmacists, health-care professionals, providers, and health coaches to stimulate, reinforce, and measure patient medication adherence behavior and performance (including factors known or thought to play a role contributing to the adoption of positive medication adherence behaviors, habits, and rate), and increase medication adherence performance rates for prescription medications closer to optimal levels as specified by manufacturer dosage and administration guidelines; (2) a compliance effectiveness/efficacy outcome program for optimized medication therapy or adherence behavior optimization, with accompanying applications, to positively impact medication adherence behavior and achieve optimal adherence, as specified by manufacturer dosage and administration guidelines; (3) a user interface, operable via smart phone, personal computer, tablet computer, or mobile computing devices, with gaming elements, to engage the patient or consumer user in adherence behavior; (4) a patient adherence teacher interface with a computer-generated personality or character (e.g., avatar) to engage the patient or consumer user in adherence behavior; (5) a database or data warehouse for storing data generated or input into the system, including compliance or quality assurance information used to conduct the analysis of patient medication adherence behaviors, including statistical analysis and determination of behavior-influencing variables and adherence rates across multiple users and medications; (6) the set of data analysis and reporting tools for such analysis; (7) a report generator for generating a variety of standard or customized reports for the various user groups; and (8) the medication identification technologies described above.

In various embodiments, the system's products, services, applications and solutions are designed to help a variety of health-care organizations study, analyze and examine the correlation between patient medication adherence or compliance, efficacy or effectiveness, and outcomes in real-world and/or research domains. These organizations include, but are not limited to, pharmaceutical manufacturers and businesses, biotechnology companies, pharmacy retailers, payors, PBMs, and provider organizations, including ACOs, HIEs, hospitals, and other health provider systems.

In one exemplary embodiment, the system thus provides real-world patient medication adherence data that is quality assured and authenticated through the system. It validates key medication adherence information at the point of medication administration, including (1) medication identification, (2) dose verification, (3) dosage (e.g., strength, form, frequency), (4) adherence results, and (5) patient attestation of authenticity of results, with permission to correlate adherence data and information with medication efficacy and patient outcomes data.

The system's data warehouse comprises numerous data elements useful in studying, analyzing and identifying correlations between medication adherence behaviors and other elements, such as the effect of co-pay reduction, demographically-relevant rewards, patient education, patient health knowledge testing, social gamification, continuous audio-visual dosing message reminders and alerts, audio-visual dosing and dosage instructions, continuous adherence performance scoring versus targets, the impact of certain adherence barriers on adherence rates, the availability and use of real-time adherence barrier problem solving modalities, the timeliness of the actual dose versus the scheduled dosing time, system notification (to providers, pharmacists, nurses, or health coaches) of patient non-adherence events related to physician-designated “critical medications”, and rewards-driven competition between participants in a social network or employer group.

The components of the system may also be used synchronously to study the effect of increasing or optimizing patient medication adherence behaviors, medication adherence, and medication adherence rates on medication efficacy/effectiveness and outcomes. The system may also be used to study correlations among and between patient medication adherence rates in a research setting or clinical trials, real-world patient medication adherence or compliance rates, and medication efficacy or effectiveness and outcomes, as well as utilization of hospital admissions, emergency room visits, procedures, diagnostic tests, and the like that occur as a result of patient medication non-adherence (and so are potentially avoidable). It should be noted that the term “optimizing” when used in relation to medication adherence or medication adherence rate means optimizing the adherence rate that would be calculated, scored and/or attributed to any patient following manufacturer dosage and administration guidelines for a particular medication.

In several embodiments, data is maintained for each patient for each scheduled dose according to a highly refined indexing protocol such that doses scheduled, doses taken, doses not taken, and related parameters for each scheduled dose for each medication, are all captured by the system. This provides highly specific medication adherence data that can be precisely correlated with dose-specific information and discrete adherence-related factors, events or behaviors. It can also be correlated to other variables related to a specific scheduled dose that is “taken” or “not taken” by the patient.

In one embodiment, a Timed Dose Opportunity Window (“TDOW”) is set for patient responses to messages (i.e., reminders or alerts) that allows for a reasonable time period for the patient to acknowledge receipt of the message, process the dose activities sequence, and send a response System dose data is maintained for each patient according to a highly refined indexing protocol such that actual doses taken or not taken for each scheduled dose for each medication is captured by the system yielding highly specific medication adherence data that can be precisely correlated with dose-specific information pertaining to discrete adherence related factors, events or behaviors, and other variables related to a specific scheduled dose that is “taken” or “not taken” or other, by the patient.

In yet a further embodiment, the system captures and stores patient-level prescription and medication information and creates an electronic cloud-based patient prescription medication record for each patient entered into the system. This record is available around the clock (“24/7”) to the patient as well as pharmacies, physicians, health coaches, and other health care professionals in the patient care chain who are granted secure access by the patient to view limited or comprehensive medication information and/or reports. This information can be used by the patient care chain to review and better understand how medication adherence performance for a particular patient may be positively or negatively impacting medication effectiveness and patient outcomes versus expected results. The prescription medication record for each patient also may be useful in aligning prescription refill dates and conducting medication reconciliation in a variety of settings across the continuum of care. Reports and tools are web-based, patient secured and HIPAA secure so that physicians can access patient level information prior to or during scheduled patient visits so that the data and information regarding a patient's adherence performance, variation by patterns by medication, dosing schedule, and patient-reported adherence barriers and system-proposed solutions can be reviewed and discussed with the patient. The system also offers a comprehensive set of automated reports available by subscription to providers who wish to study medication adherence patterns of their patient population in greater detail and explore correlations or patterns among variables that may affect medication adherence, medication adherence behaviors, or medication adherence rates.

The information stored in the system includes patient demographics, and detailed contact information for pharmacy of record and pharmacist(s), primary care physicians, specialists, physician extenders such as nurse practitioners or physician assistants, and health coaches. It also may include detailed prescription information including name of each medication, prescribing physician, dosage instructions, medication description and image, dates prescription initially filled, refill and patient pickup or delivery dates; number of doses dispensed, special instructions such as cautions and warnings, patient insurance information, and detailed and redundant digital and electronic contact information for each patient (including primary and secondary mobile phone number, text address, email address). Similar contact information for each patient's designated health coach and certain designated physicians or their practice designees (such as a nurse, nurse practitioner or physician assistant, or care coordinator, who is an authorized user of the system and granted access to certain information as approved by one or more patients) may be maintained. The system also includes system user documents, waivers and releases in relation to respective responsibilities of pharmacy, pharmacist, prescribing physicians, limitation of liability; and HIPAA authorizations, as well as patient certificate of compliance program authorization, enrollment and acknowledgement data by patient and pharmacist (including attestations of accuracy of information and acknowledgement that use of the system to achieve financial benefits such as co-pay reductions or rewards by entering false information is a violation of law and may constitute insurance fraud or a felony offense punishable by fines and jail sentence), HIPAA policy review, all appropriate waivers, releases, and authorizations, as well as a repository of all required signatures in electronic format.

In several exemplary embodiments, the system communicates with the patient on a secure two-way around-the clock (“24/7”) real-time basis via smartphone, desktop personal computer, tablet computer, or other mobile device. It provides medication dosing reminders and alerts, adherence barrier solutions, adherence performance scores, and continuous updates regarding co-pay dollars and rewards points earned versus potential. The system also communicates multi-directionally (i.e., to more than one user group) on a similar real-time basis with healthcare professionals or a health coach approved by the patient (based on options selected and authorized by the patient and with the agreement of any third party, such as the healthcare professional or health coach).

The system also can operate in a disconnected mode, where the user device is not connected to the main system data centers (which can result from a variety of reasons, technical or operational). In disconnected mode, the local program stores adherence information, date/time stamps, GPS coordinates, and any other relevant data locally on the user's device. This information is then sent to the system data centers (e.g., in the cloud) when communications are restored, thereby causing the system to update and sync the adherence and medication data.

The system continuously calculates overall and medication-specific patient adherence rates for individual patient members of the system by comparing a particular patient's time- and date-stamped medication-specific response to a particular time- and date-stamped medication-specific dose reminder and alert. The system also captures and stores the time and date of missed doses by medication as well as the primary reason the patient reports for having missed a particular dose. The system also proposes issue-specific solutions to each medication adherence barrier the patient reports for a particular dose of a medication (e.g., providing information about refilling). The system calculates and maintains accurate medication adherence rates, time-to-dose statistics, primary reason(s) for a particular missed dose(s), adherence solutions proposed by the system, patient response and correlating adherence result, and the specific description of any side effects reported by the patient with a particular medication. Certain medications for which medication non-adherence is associated with high-risk consequences based on medication or medical condition or disease state may be designated as “Critical Medications.”

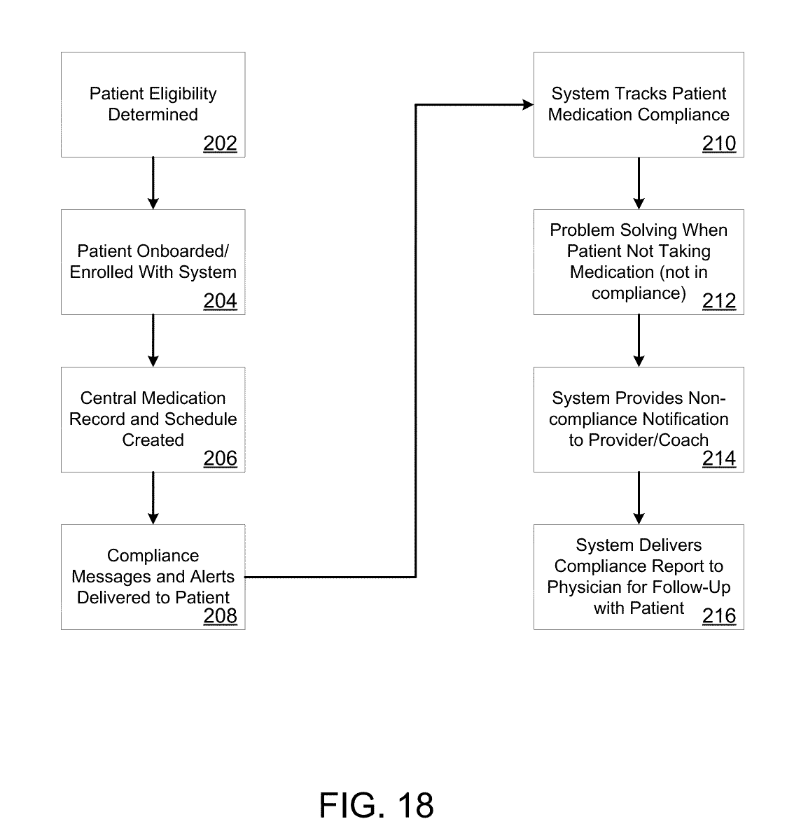

FIG. 18 shows an example of patient flow in an exemplary system of the present invention. The owner or operator of the system contracts with a payor (i.e., a risk-bearing entity relative to healthcare costs for a specified population). Payors include, but are not limited to, a self-insured employer, health insurer, health insurance plan, ACO, or the like. First, patient eligibility is determined and confirmed 202. Eligibility for a program embodying the present invention can be done directly by the system (i.e., by contacting members of the insured population to activate each member's medication compliance benefits), or through the payor, or through a healthcare provider or pharmacist, among other methods. An eligible patient can then enroll or “onboard” with the system in a variety of ways: e.g., a system call center representative may directly contact the patient (with new or existing prescriptions), a pharmacist or physician may onboard the patient, or a pharmacist, physician, or care coordinator may direct the patient to the system call center 204.

In several embodiments, the pharmacist, physician, care coordinator, call center representative, or similar person (such as, but not limited to, a system-trained and certified pharmacy tech or administrative member of the pharmacy team), provides a brief summary to the patient of the importance and health benefits of achieving and maintaining a high rate of medication adherence and persistence (as well as their respective definitions and layperson meaning). This counseling session includes a brief but clear explanation to the patient of the compliance-effectiveness-outcomes correlation, historic average ranges of patient medication adherence, common causes of patient medication non-adherence, and a brief description of how the system works to help the patient the achieve a high rate of adherence. It will include a concise summary of all of the benefits of participating in the system. In addition to potential health and quality of life benefits of medication compliance, other benefits include copay reduction or elimination, consumer-patient specific rewards, around-the-clock dosing reminders and alerts, dosage instructions, images of the medication to be taken, cautions and warnings, real-time interactive adherence barrier problem solving features, critical meds non-adherence alerts to designated health coach, physician or designee such as a care coordinator, nurse or case manager, and disease or condition-specific education and information with lifestyle and wellness recommendations.

In one embodiment, the patient enrollment or onboarding protocol comprises:

a. Representative verifies patient releases and agreement are signed;

b. Representative explains clinical and economics benefits of program;

c. Representative and patient log into file sharing and viewing application;

d. Representative logs in to patient's pharmacy record via pharmacy portal or through the system onboarding portal (in situations where the system receives pharmacy records digitally through an interface);

e. Representative confirms medication list is accurate and updates if needed;

f. Representative completes central medication schedule and record based on patient preferences 206;

g. Representative uploads enters medication schedule into system;

h. Representative coaches patient through download of system application to smart phone and/or desktop computer to provides link to the system;

i. Patient connects first time to the system through system application, creates final password, verifies data and digitally signs any remaining legal documents;

j. Patient begins using system.

The system them provides compliance messages and alerts to the patient 208, and tracks patient medication compliance 210, as described more fully above. If the patient is not in compliance, the system actively initiates problem-solving procedures and techniques to address the problem 212. The system may provide not-compliance notifications to the patient's healthcare provider and/or healthcare coach 214, and compliance reports to the patient's physician 216.

In further embodiments, compliance certification is provided by the system, such as the determination of adherence scores. The system may seek waivers from patients to examine claims for emergency room visits, hospital admissions, test, procedures, and the like. Patients may receive premium or co-pay reductions, as well as other incentives offered by an insurer or plan.

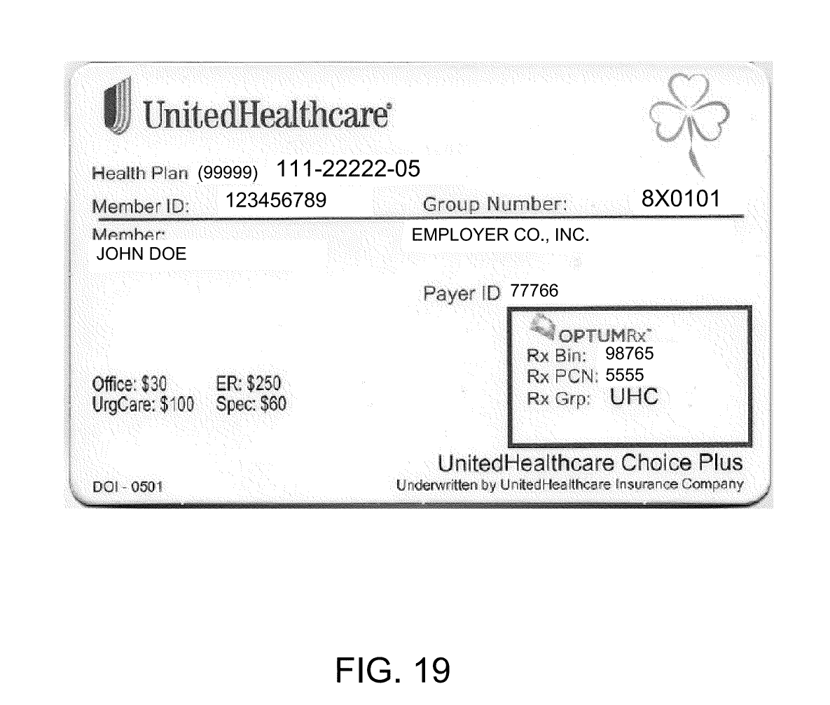

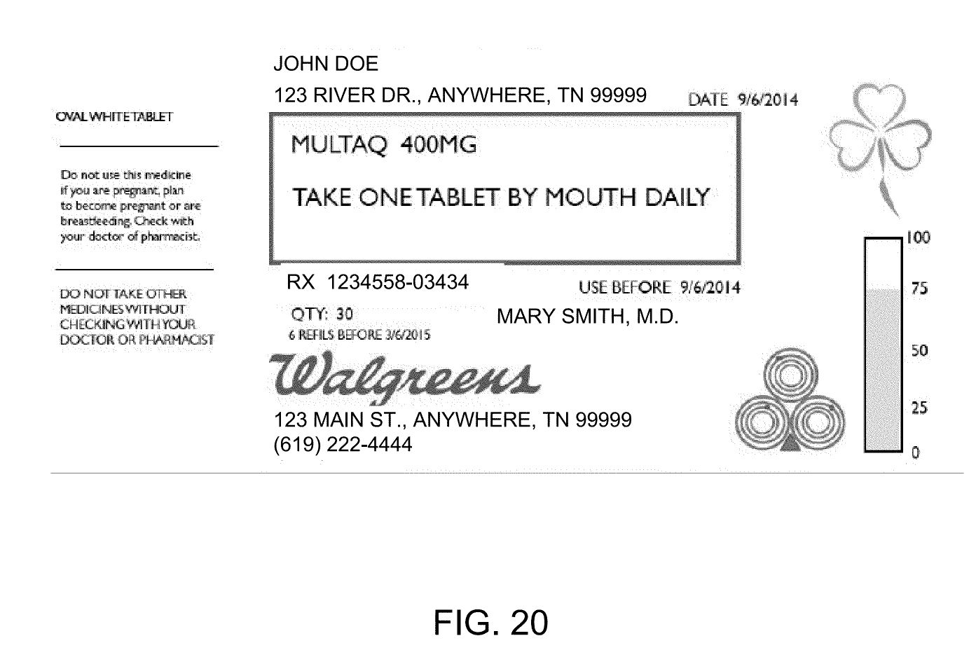

In several additional embodiments, the system comprises a “Compliance Optimization” component. Compliance Optimization is a combination of (1) technology that reminds patients to take medications, confirms dose taking, and captures and stores objective medication compliance data and related information regarding medication consumption; (2) a funding mechanism for patient medication compliance rebates; (3) the applications of the funding for patient compliance rebates relative to a particular medication, list of medications, and/or schedule of medications; (4) a system and process for tracking, analyzing, and adjudicating patient compliance rebates using objective compliance data; (5) mobile and cloud based applications to display the quantified level of medication compliance rebate for which the patient is eligible and the percentage or dollar amount earned at particular time intervals or one measurement dates; (6) notification of eligibility for medication compliance rebates by the presence of a system logo on the patient's health insurance card (if insurer has agreed to this feature), as seen in FIG. 19; (7) a “Smart RX” prescription label that shows medication compliance rate on a year-to-date basis, the previous month or refill period, as a component of the main prescription label or as a supplemental label affixed to the prescription label, as seen in FIG. 20; and (8) supplemental information regarding medication compliance and/or adherence which may be inserted in the bag containing prescription drugs sold to a pharmacy customer. A code mark as discussed above may be placed on actual medications such as a tablet for scanning and identifying a particular medication.

The Compliance Optimized formulary lists medications that fall into the category of Compliance Optimized medications as described above. In several embodiments, the system permits all medications, generic or brand, to become Compliance Optimized medications according to the protocol described above. This includes their respective selection to a particular formulary if a closed formulary is applicable. Manufacturers of generic or brand medications support compliance optimization of their respective products by offering (in most cases through the payer and its formulary) a specific quantified level of patient compliance rebate in dollars for a particular product it manufactures and/or markets. Compliance Optimization may be mediated and reinforced by healthcare providers, especially physicians and pharmacists, as well as care coordinators of payors or other organizations who access patient medication compliance profiles, reports and/or data through the system. Such entities may use profiles, reports and/or data to counsel patients regarding their medication compliance rates, trends and patterns, thereby supporting and contributing to compliance optimization for prescribed medications of the patient and compliance results.

In order to provide a context for the various aspects of the invention, the following discussion provides a brief, general description of a suitable computing environment in which the various aspects of the present invention may be implemented. A computing system environment is one example of a suitable computing environment, but is not intended to suggest any limitation as to the scope of use or functionality of the invention. A computing environment may contain any one or combination of components discussed below, and may contain additional components, or some of the illustrated components may be absent. Various embodiments of the invention are operational with numerous general purpose or special purpose computing systems, environments or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, cell phones, personal digital assistants (PDAs), network PCs, minicomputers, mainframe computers, embedded systems, distributed computing environments, and the like.

Embodiments of the invention may be implemented in the form of computer-executable instructions, such as program code or program modules, being executed by a computer or computing device. Program code or modules may include programs, objections, components, data elements and structures, routines, subroutines, functions and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices.

In one embodiment, a computer system comprises multiple client devices in communication with at least one server device through or over a network. In various embodiments, the network may comprise the Internet, an intranet, Wide Area Network (WAN), or Local Area Network (LAN). It should be noted that many of the methods of the present invention are operable within a single computing device.

A client device may be any type of processor-based platform that is connected to a network and that interacts with one or more application programs. The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein. Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media that may transmit or carry instructions to a computer, including, but not limited to, a router, private or public network, wired network, direct wired connection, wireless network, other wireless media (such as acoustic, RF, infrared, or the like) or other transmission device or channel. This may include computer readable instructions, data structures, program modules or other data in a modulated data signal such as a carrier wave or other transport mechanism. Said transmission may be wired, wireless, or both. Combinations of any of the above should also be included within the scope of computer readable media. The instructions may comprise code from any computer-programming language, including, for example, C, C++, C#, Visual Basic, Java, and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface.

Client devices may operate on any operating system capable of supporting an application of the type disclosed herein. Client devices also may support a browser or browser-enabled application. Examples of client devices include, but are not limited to, personal computers, laptop computers, personal digital assistants, computer notebooks, hand-held devices, cellular phones, mobile phones, smart phones, pagers, digital tablets, Internet appliances, and other processor-based devices. Users may communicate with each other, and with other systems, networks, and devices, over the network through the respective client devices.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. An apparatus for assisting with medication adherence, comprising:
a computing device with global positioning capability, said device comprising a microprocessor coupled to a memory, wherein the microprocessor is programmed to assist medication adherence by:
displaying a medication schedule for a user;
sending reminders via electronic communications to the user to take medications according to said medication schedule;
recording the time and location when the user takes a dose of medication; and
calculating adherence ratings for the user based upon the user's record of taking medication.

2. The apparatus of claim 1, wherein the computing device is a mobile computing device.

3. The apparatus of claim 1, further wherein the microprocessor is programmed to assist medication adherence by:
prompting the user to scan a code on the medication or a medication container when the medication is taken.

4. The apparatus of claim 1, further wherein the microprocessor is programmed to assist medication adherence by:
prompting the user to enter a reason for not taking a dose of medication according to the medication schedule.

5. The apparatus of claim 1, further wherein medication adherence reports are provided to healthcare providers or insurer or payors for the user.

6. The apparatus of claim 1, further wherein one or more adherence ratings are printed on a label on a medication container.

7. The apparatus of claim 1, further wherein the user receives a reward, discount, or rebate, or combinations thereof, for adherence ratings above a pre-established threshold.

8. A method for promoting medication adherence, comprising the steps of:
displaying, using a microprocessor in a computing device, a medication schedule for a user;
sending reminders via electronic communications to the user to take medications according to said medication schedule;
recording, using the microprocessor, the time and location when the user takes a dose of medication; and
automatically calculating adherence ratings for the user based upon the user's record of taking medication.

9. The method of claim 8, wherein the computing device is a mobile computing device.

10. The method of claim 8, further comprising the step of scanning a code on the medication or a medication container when the medication is taken.

11. The method of claim 8 further comprising the step of prompting the user to enter a reason for not taking a dose of medication according to the medication schedule, if the user does not take a dose of medication.

12. The method of claim 8, further comprising the step of providing medication adherence reports to healthcare providers or insurer or payors.

13. The method of claim 8, further comprising the step of providing the user a reward, discount, or rebate, or combinations thereof, for adherence ratings above a pre-established threshold.
